(19) United States
(12) Patent Application Publication
(10) Pub. No.: US 2016/0334547 A1
(43) Pub. Date: Nov. 17, 2016

(54) Method and Apparatus for Localized Vehicle-Sourced Weather Observations

(71) Applicant: Ford Global Technologies, LLC, Dearborn, MI (US)

(72) Inventors: Perry Robinson MacNeille, Lathrup Village, MI (US); Yimin Liu, Ann Arbor, MI (US)

(21) Appl. No.: 14/713,638

(22) Filed: May 15, 2015

(51) Int. Cl. G01W 1/02

(52) U.S. Cl. CPC G01W 1/02

(57) ABSTRACT

A system includes a processor configured to receive recorded weather-related observation data from a plurality of vehicles in a building locality. The processor is also configured to combine the received weather-related observation data with remote weather data received from a remote source. Further, the processor is configured to determine a weather pattern developing in the building locality based on the combined weather-related observation data and remote weather data.

### TECHNICAL FIELD

The illustrative embodiments generally relate to a method and apparatus for localized vehicle-sourced weather observations.

### BACKGROUND

The occurrence of random and severe weather events can be very expensive for various industries. It has been estimated that an unplanned plant shutdown for an automaker could cost the automaker as much as $60-$100 thousand per minute, which is over $100 million per day for a plant running three shifts. Similarly, unplanned shutdowns due to weather can impose a severe impact on many other industries.

With respect to the automotive field, as a source of examples: vehicles stored in parking facilities may be damaged by the severe weather; anticipated severe weather that never materializes can cost millions when an unnecessary shutdown occurs; and when unanticipated severe weather does occur, millions in damage can result to both people and property, as well as loss of revenue and productivity due to damage and shutdown.

One problem with mitigating this damage is that accurate information is rarely available during conditions leading up to severe weather events. Cloud cover can prevent satellite systems from providing sufficient assistance. Turbulence in the range of 1000 meters above the ground can mean the difference between a tornado touching down or gliding safely above a site with nominal consequences. Even when conditions are clear, and certainly when conditions are cloudy, satellite systems struggle to accurately measure surface conditions. Similarly, Doppler radar struggles to provide accurate results close to ground level.

The idea of gathering weather data at a vehicle has been proposed. One suggestion includes an arrangement and method for monitoring weather that includes a sensor system arranged in vehicles for obtaining information about the weather in the vicinity of the vehicle, a communication system arranged in each vehicle and coupled to a respective sensor system for communicating the obtained weather information to a control station or other remote facility, and a transmission system arranged at the control station for transmitting weather conditions in an area in which the vehicles travel based on the information obtained by the vehicles. A positioning system may be arranged on each vehicle to determine its position so that the communication systems transmit the position of each vehicle along with the obtained information. A display may be arranged in each vehicle for displaying the transmitted weather conditions to an occupant of the vehicle.

Another example includes commonly owned U.S. application Publication Ser. No. 13/030,504, filed on Feb. 18, 2011, the contents of which are hereby incorporated by reference. In this solution, a computer-implemented method of gathering data includes querying, via a vehicle computing system, a plurality of weather sensors included with a vehicle and in communication with a vehicle network. The method also includes determining whether or not appropriate conditions exist for storage of data from the sensor, for each of the sensors. Additionally, the method includes storing the data from the sensor if appropriate conditions exist. Finally, the method includes sending, from the vehicle computing system to a remote network, data from one or more queried sensors and current GPS coordinates of the vehicle.

With both of the above examples, the idea is to use sensors on a vehicle to gather weather data. Much more can be done, however, to make this data meaningful and useful.

### SUMMARY

In a first illustrative embodiment, a system includes a processor configured to receive recorded weather-related observation data from a plurality of vehicles in a building locality. The processor is also configured to combine the received weather-related observation data with remote weather data received from a remote source. Further, the processor is configured to determine a weather pattern developing in the building locality based on the combined weather-related observation data and remote weather data.

In a second illustrative embodiment, a system includes a processor configured to receive data, indicating a light source presence, from a first vehicle providing the light source. The processor is also configured to receive data, indicating a light source strength, from a second vehicle having a sensor capable of detecting the light source. Further, the processor is configured to compare the received data from the first and second vehicle to stored data previously received from the first and second vehicles and determine a change in visibility based on the compared data.

In a third illustrative embodiment, a system includes a processor configured to receive wind data from a plurality of vehicles located within a predefined distance of each other and more than a predefined distance apart from each other. The processor is also configured to compare directional wind data included with the wind data and determine the shape of a local wind pattern based on the comparison.

### BRIEF DESCRIPTION OF THE DRAWINGS

FIG. 1 shows an illustrative vehicle computing system;

FIG. 2 shows an illustrative vehicle sensor and data reporting system;

FIG. 3 shows an illustrative data gathering and processing system including multiple vehicles;

FIG. 4A shows an illustrative visibility determination system using vehicles;

FIG. 4B shows an illustrative process for vehicle communication and visibility determination;

FIG. 5 shows an illustrative vehicle discovery process;

FIG. 6 shows an illustrative system for cyclonic air detection using vehicles; and

FIG. 7 shows an illustrative process for cyclonic air detection.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

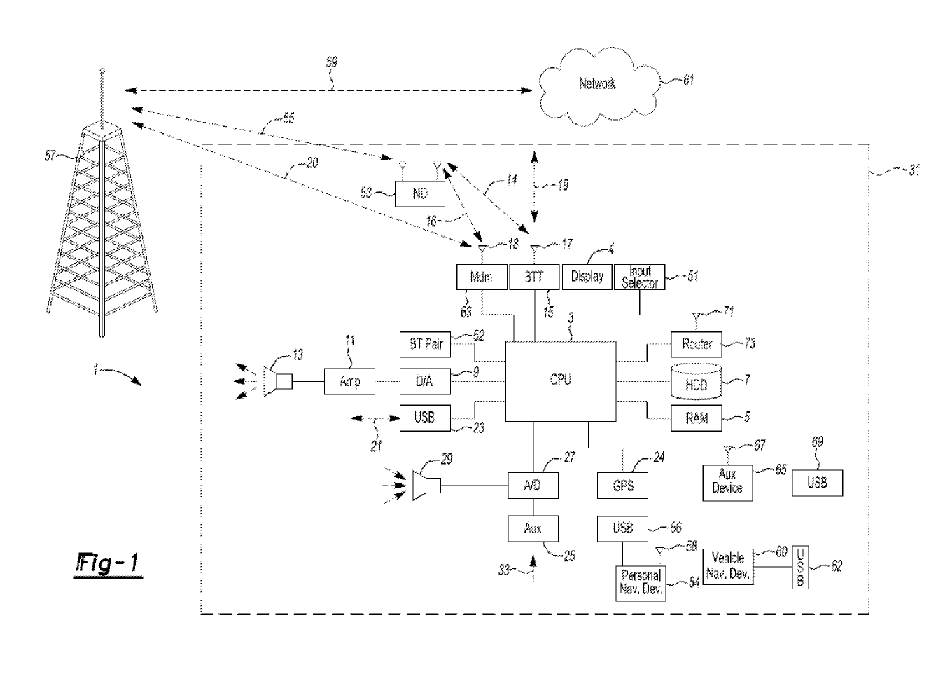

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

In the illustrative embodiments, the data gathering goes far beyond data observation merely based on accumulated points of data based on vehicle reporting. That is, in the previous solutions, vehicles were proposed to gather data and report the data back to a central source, functioning as weather modules. In the proposed solution vehicles in a small, local area make observations and the observations can be related to each other to predict the onset of severe weather conditions in the area.

In the proposed examples, use is made of connected cars in the vicinity of a local data processing center (which could, for example, be installed in a plant or business, or could be installed at a remote source to service the plant or business and be provided with data through a relay). Since vehicles are small, near the ground and contain a number of sensing technologies usable for normal operation (i.e., for the intended traveling usage), they are also usable to measure and gather data usable to make determinations about severe weather conditions that may be forming.

Among other things, vehicles are typically equipped with position detectors (e.g., GPS), temperature and barometric pressure measuring devices, and may even be equipped with humidity measuring devices. These are frequently provided to meet emissions and fuel economy standards, but the re-tasking of the data from these sensors is a relatively simple task. Vehicles may also be equipped with accelerometers that can measure directional movement of a vehicle (or vehicle turn-over), rain sensors (used for engaging automatic wipers), and pyrometers to measure available sunlight. Wind speed (and direction) around a parked vehicle can be estimated by rocking of the vehicle as measured by accelerometers. Vehicle microphones can pick-up sounds in the vicinity of the vehicle (howling wind, hail, etc.). Ultrasonic detectors, used for backup collision avoidance and parking aids are also often present.

New sensors are also constantly being added to vehicles. For example, a suspension height sensor can be used to detect roll, pitch and lift due to wind on a parked vehicle. Infrared sensors (usable to detect road temperatures and black ice) can be used to make assumptions about convective available potential energy (CAPE), which is an important factor in storm determination. Typical consumer vehicles may have many sensors useful as above for aiding in driving, and commercial vehicles may even have small weather stations with devices configured to measure wind speed and direction, precipitation rate, temperature, barometric pressure and relative and specific humidity.

In the illustrative examples, the sensors in a given vehicle are connected to a vehicle computer through one or more vehicle networks. The vehicle computer(s) can be used to reduce sensor data to meaningful meteorological values and send it, along with time and location stamps, if needed) to a nearby data processing center. The data processing center can also receive weather services, geographical information, climatological and news services.

The vehicles may also be capable of vehicle-to-vehicle communication to cooperate to determine weather-related information not necessarily observable from a single vehicle data set alone. For example, without limitation, a first vehicle could engage a lighting system and secondary vehicles could report any observed change in illumination to determine current visibility conditions or changes in those conditions. Ultrasonics can determine wind speed and density based on the known range between two vehicles. Chemical analysis of exterior air, such as used for cabin air quality measurements, can be used to detect chemical tracers that help determine air movements for particle analysis.

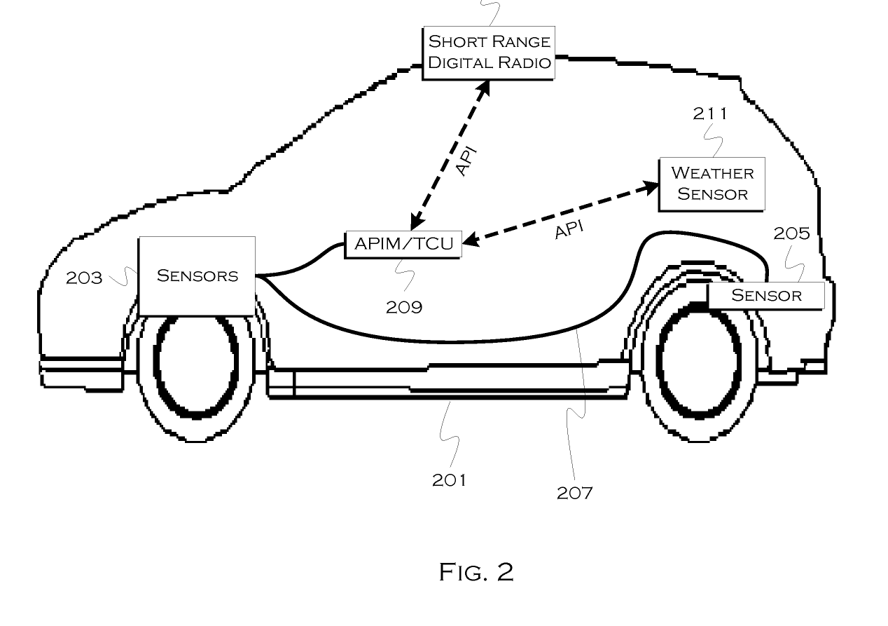

FIG. 2 shows an illustrative vehicle sensor and data reporting system. This is an example of a single vehicle equipped with a sensor suite that can be used as part of a multi-vehicle solution as later described. This is just one example of a vehicular sensor suite and is only intended for illustrative purposes to facilitate understanding.

In the example shown in FIG. 2, vehicle 201 is provided with a variety of sensors 203 and 205. These can include, but are not limited to, barometric pressure, humidity, air quality, accelerometers, ultra-sonic, infrared, rain-sensors, pyrometers, GPS sensors, microphones and cameras. In this example, all the sensors connect through a vehicle bus 207 to a central processing unit 209. Through the use of one or more application programming interfaces (API)s, the CPU can also communicate with any brought-in sensors 211.

Once any meaningful or useful data has been gathered, the data can be processed locally and communicated to a remote processing center for analysis, and/or communicated in raw form if that is preferable. Through use of a short-range digital radio 213, communicating with the processing unit, this data transference can occur. Other suitable methods of communication may also be utilized as appropriate.

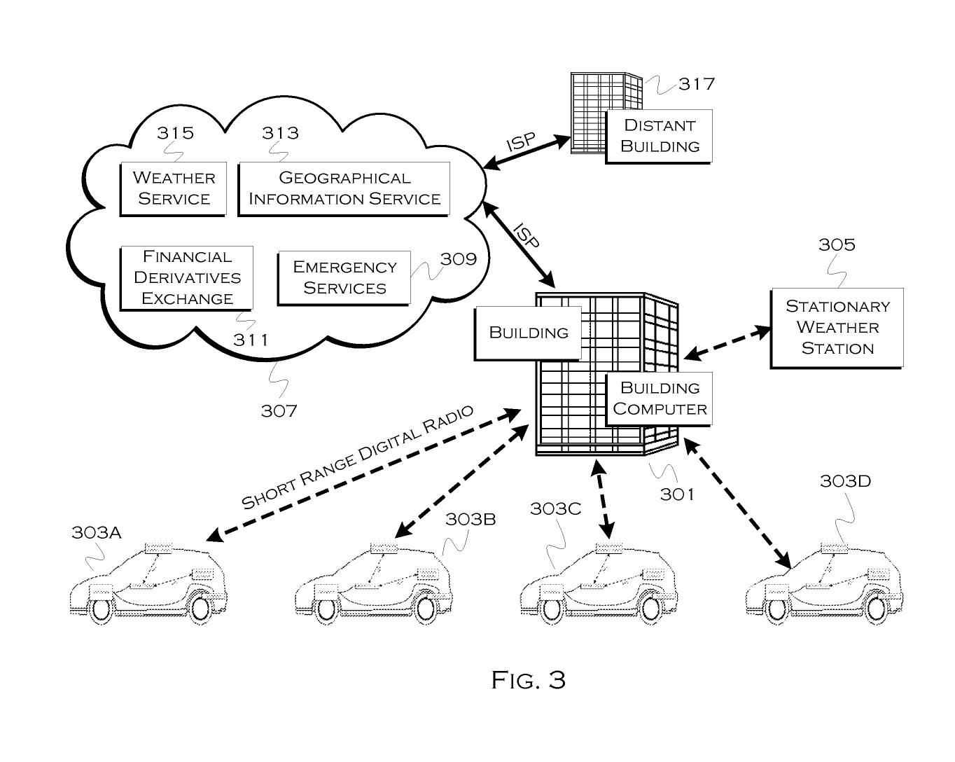

FIG. 3 shows an illustrative data gathering and processing system including multiple vehicles. In this illustrative example, a plurality of data gathering vehicles 303A, 303B, 303C and 303D are parked in proximity to a building 301. The building, in this example, contains a weather analysis processing unit and is capable of wireless communication with the vehicles through short range digital radio (or another appropriate standard). The building also, in this example, communicates with one or more weather stations 305, which may contain additional equipment that is not commonly included in the vehicles for supplementing local weather data.

Further, in this example, the weather analysis processing computer in the building communicates with the cloud 307, to gain access to, for example, data from a distant building or buildings (showing weather movement towards the present building), and Internet services such as, but not limited to, weather services 315, geographical information services 313 and emergency services 309.

Also, in this example, communication with a financial derivatives exchange 311 is provided, which can provide some form of risk-based mitigation from a financial perspective, using the gathered data to more accurately formulate a cost-tradeoff for purchasing insurance or other protection to cover immediate and short-term events. Since the present examples provide a methodology through which precise information can be gathered, appropriate pricing of derivatives and options against immediate catastrophe can be more accurately performed.

In this example, the central unit in the building gathers all the relevant data and makes an analysis of any inclement weather conditions warranting action. Additional specific needed data can be immediately requested and returned in an on-demand fashion, and since the majority of the vehicles will be simply remaining in the vicinity at any given time, a high expectation of an answer to most data requests can be expected, as well as a high level of prompt return of data to requests.

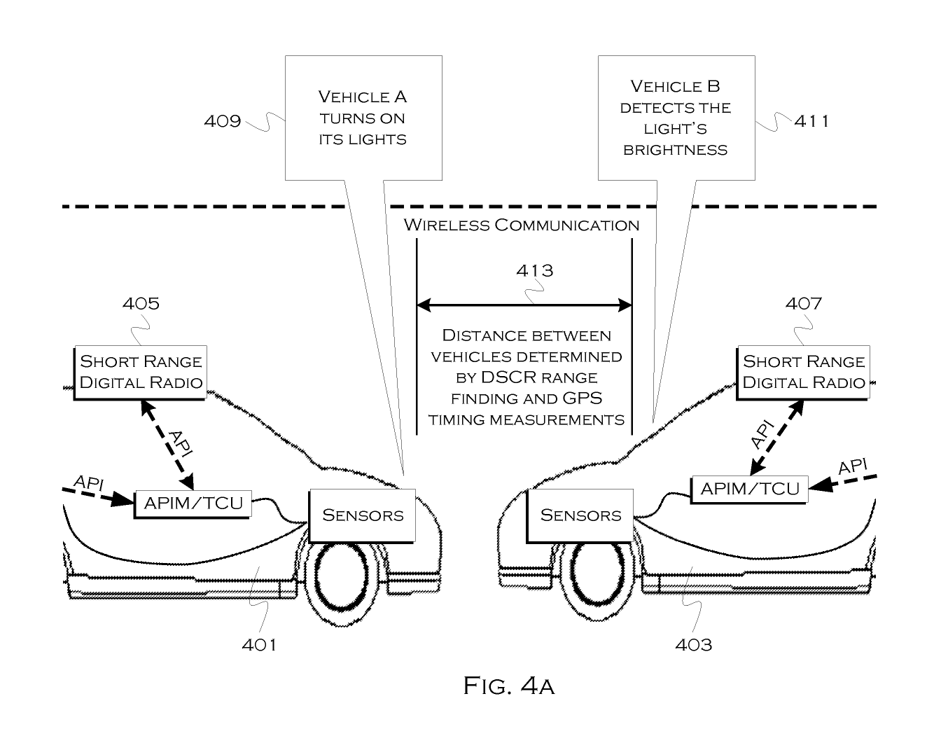

FIG. 4A shows an illustrative visibility determination system using vehicles. This is just one example of how vehicles can act in concert to provide data that a single vehicle may not otherwise be able to provide. Further, this is an example of data that cannot easily be obtained through satellites, Doppler radar or other more conventional weather-data gathering systems. Additionally, since the data is coming from vehicles that are in the immediate vicinity of a building, the data is accurate on a highly local basis, and thus provides much more relevant considerations than data gathered by, for example, a weather station three miles away. The danger and severity of many weather events (tornados, large hail, micro-bursts, etc.) is often most felt and relevant in a very localized area, and thus data relating to the immediate vicinity of a locale is very relevant to the impact the weather will have on that specific area. Data from further-off locations may largely be useful in a somewhat inaccurate predictive sense (i.e., all data indicates that a high likelihood of a tornado exists, but the general data can only give a very rough projection of if and where that tornado might actually touch down and do some real damage.

In the example shown in FIG. 4A, two vehicles 401 and 403 are both located in a parking lot near a building, and vehicle 403 has a line of sight to vehicle 401, or can otherwise detect light emission from vehicle 401. This could have been established at an earlier point in time, or, for example, just before a visibility test is performed. Due to the possibility of intervening non-weather-related obstacles, it may be desirable to measure results from a plurality of vehicles viewing vehicle 401, so that outliers can be discarded. In this example, the vehicles may have the same or different sensors provided thereto, but in order to facilitate this process only the viewing vehicle 403 (and other viewing vehicles) needs to be provided with some sensor for measuring or detecting the light output from vehicle 401.

Both vehicles can communicate with each other using, for example, short range digital radios 405 and 407. This short range communication can be useful to coordinate efforts and to ensure, for example, that vehicle 403 is still a viable candidate vehicle (e.g., sensors are working, some change in light is measured, communication is working, vehicle is still present and at a previously working heading/location, etc.).

In this example, when vehicle 401 turns on its headlights 409, it can relay this information to vehicle 403 and vehicle 403 can determine any change in detected light based on an observation of the engaged lights 411. This information can then be relayed to a processing center, which may use this and other data (time of day, for example) to determine the importance of noted changes in light levels (e.g., now compared to moments before or earlier in the day).

FIG. 4B shows an illustrative process for vehicle communication and visibility determination. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

This is an illustrative example of the processes that may occur at each vehicle when the light-detection procedure occurs. In this illustrative example, at vehicle A, a search for viable candidates occurs 421. In this example, the search is for vehicles that previously were identified as viewing the lights of vehicle A, or are presently situated and in a suitable heading for viewing the lights. Confirmation of the visibility might also be performed at this time, if appropriate. Accordingly, vehicle A sends out a candidate request 421 that is received by vehicle B 431.

When the request is received by vehicle B, in this example, vehicle B determines if it has the necessary sensing capability to assist vehicle A 433. In some instances of vehicles acting in concert, it may be necessary for all the vehicles to have the same or certain sensing capability. In this example, as long as vehicle B has the capability to sense light emitted by vehicle A, then vehicle B can assist (from a sensory perspective). If the vehicle B in this example has adequate sensory capability, it returns its location and heading to vehicle A, so that vehicle A can assess if vehicle B is a viable location candidate for assistance. In other examples, the central server with which the vehicles communicate can provide suggested candidates and assist in coordinating vehicle efforts. Or, in still another example, vehicle A can broadcast a location and heading and the receiving vehicles can use this information to self-determine if they are location-viable.

If vehicle A establishes the candidacy of vehicle B (in this example) then further communication will be possible between A and B for the purposes of measuring light changes 437. If no further communication is received by B, the process may exit after some timeout, since A is no longer communicating with B.

Once vehicle A engages exterior lighting (e.g., headlights, high beams, etc.) 423, it may send an inquiry out to vehicle B (or multiple vehicle Bs) to determine if any of the candidate vehicles can see the lights 425. Even if vehicle B has adequate sensors and an appropriate location and heading, any number of physical obstacles unrelated to weather may make the vehicle an inappropriate candidate, and actual visibility of the emitted light from A will help confirm the viability of vehicle B as an assisting vehicle. Vehicle A may also transmit to vehicle B that the lights have been engaged, and vehicle B will attempt to detect the lights of vehicle A 439.

If the lights are not visible 441, the process may exit (or return “lights not visible” and exit), since vehicle B may not be able to see vehicle A. If the lights are visible 441, the process may return a confirmation to vehicle A 443. At this point, either or both vehicles may determine a distance between the vehicles 427, 445, which can be done by GPS coordinates (or other, more precise, location based sensing). If a single observation of lighting is made, it may be useful to have highly precise distances known so that an expected value of light can be measured. If multiple observations are made, however, as long as the vehicles haven't moved (determinable by a delta of) or near 0 in determined distances in each instance), the change in visible light can be observed and extrapolations can thus be made about a change in visibility.

In this example, vehicle B determines any deterioration in light from a previous observation 447 (the multiple-test scenario), and if the determination was an initial one, then initial data may simply be reported. The relevant (initial or deterioration) data can then be sent to the central server 449. In other examples, vehicle A may make these determinations (based on data from B) or the raw data may be sent to the server and the server can make the determinations.

Also, in this example, vehicle A saves viable candidate matches for this test 429, to establish a minimum data-set for candidates usable in future inquiries. This can be especially useful if, for example, a series of tests is to be performed over a ½ hour (or other limited time) period in which visibility changes are to be measured and vehicles are unlikely to move. Also, which vehicle provides the lighting can be varied to preserve light and battery life, although it is most useful to have the same vehicle provide the lighting in any given set of comparisons, since it will give accurate observations of the same source for comparison purposes.

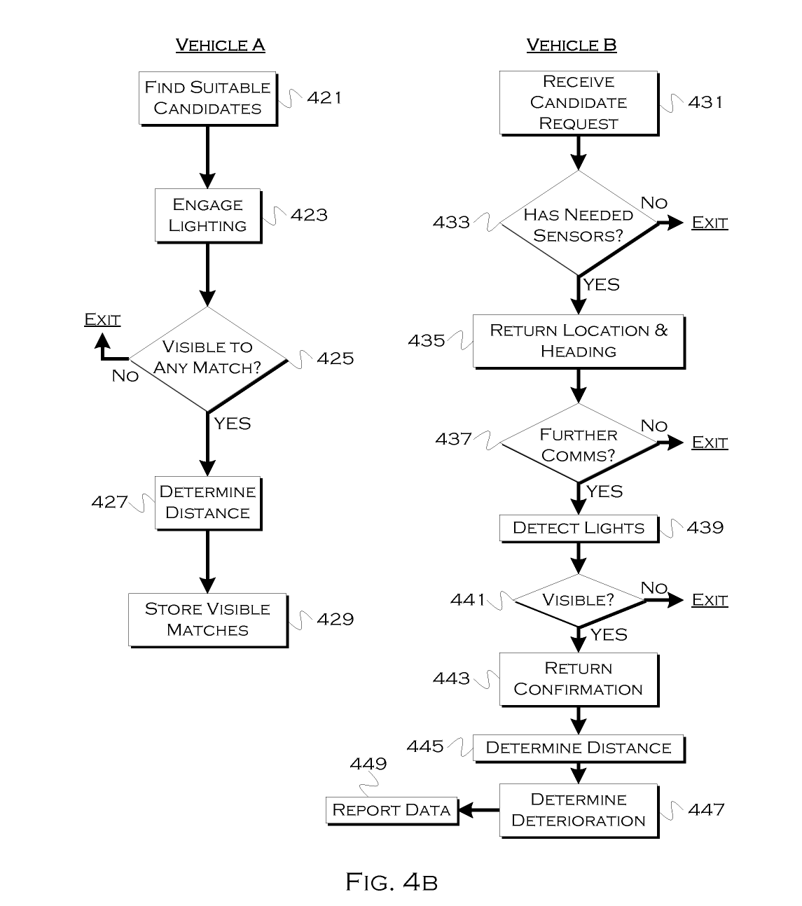

FIG. 5 shows an illustrative vehicle discovery process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, the vehicle searching for candidates (e.g., vehicle A) will broadcast a request for the location of surrounding vehicles that may be eligible for assistance 501. From each vehicle that receives the request, a location and heading is received back by the requesting vehicle 503. In the example shown in FIG. 4, only vehicles that also have appropriate sensors respond, but the request can be used in the absence of sensor-determinations just to get a sense of surrounding vehicles (e.g., the nature of the surrounding vehicles may be determined and then which test to run may be determined). In this example, if any vehicles respond with suitable locations and/or headings to provide assistance in a test 505, the process will continue communication with those specific vehicles 507 and ignore non-viable candidate vehicles to minimize communication.

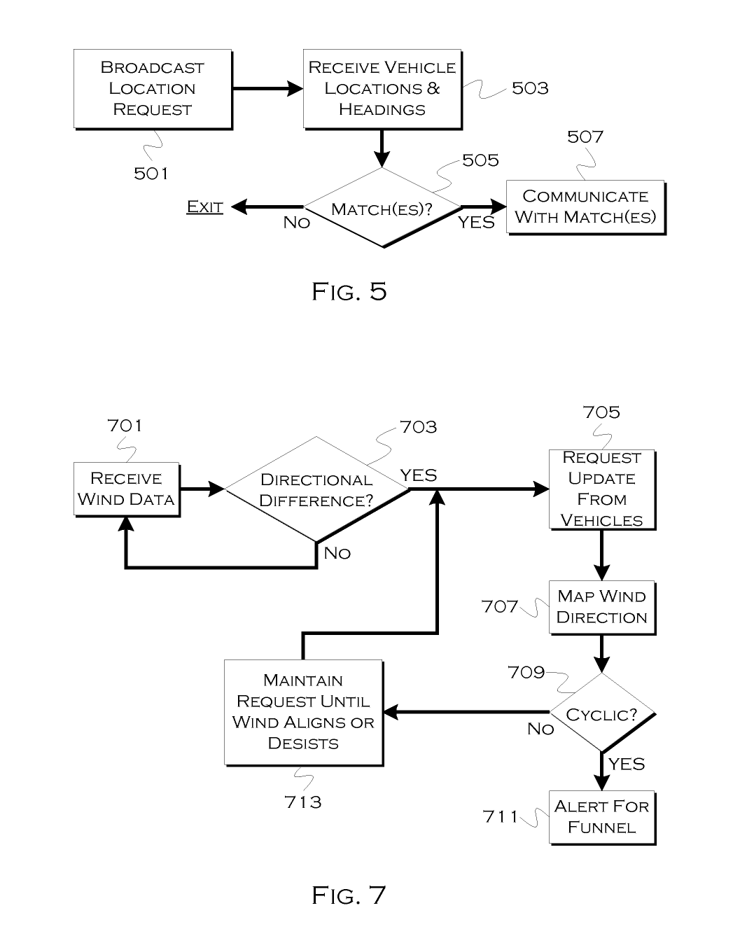

FIG. 6 shows an illustrative system for cyclonic air detection using vehicles. In this illustrative example, vehicles A 601, B 603 and C 605 are located at different locations in a parking lot or parked around a building, forming points on the edge of a circular (or ovular) area between them. It's not essential that the vehicles be in a circle, but it is more useful if the data points are spread out a bit within the limited local area so that meaningful wind patterns can be observed. In this example, the vehicles can communicate with each other (and with any central computer) using wireless communication 609.

The vehicles may communicate to the other vehicles what direction and/or windforce each vehicle is observing. In this example, vehicle A may observe wind from the north, vehicle B may observe wind from the south and vehicle C may observe wind from the east. Given their relative locations (observable from vehicle positioning data), these observations indicate cyclonic airflow 607.

If random or cyclonic airflow is detected at the ground level, it is a good indication that random wind buffets or cyclonic patterns are developing, respectively. Each can be an indicator of severe or irrational weather, and appropriate precautions may be taken and/or increased monitoring may occur.

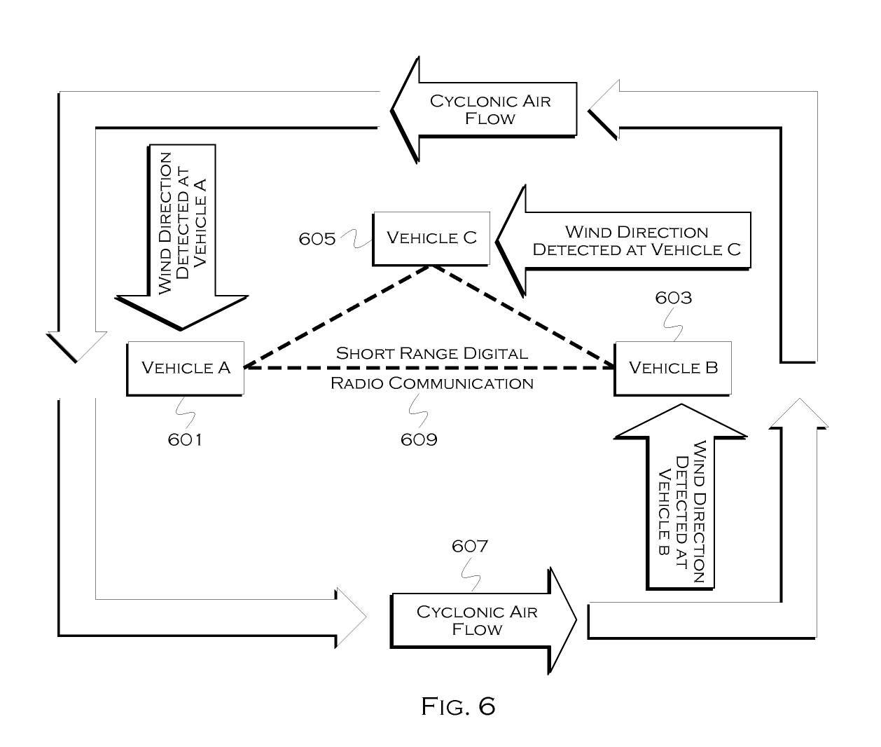

FIG. 7 shows an illustrative process for cyclonic air detection. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, a central processing system receives airflow and wind force data from a plurality of vehicles located in a localized area 701. If there is no differential in the directions in the data, then no action is taken. Since this process may be looking for cyclonic air indicia, the process may also take steps to ensure a broad enough sample (i.e., vehicles aren't all within a few feet of each other) is used.

If there is indicia of different wind directions 703, the process may request frequent updated vehicle data to confirm wind patterns 705. Cyclonic airflow may continue in an established pattern, and repeated sampling can help discard temporary random data. Based on the received, updated data, the process may map the wind data to see if a dangerous pattern is present 707. If there is a cycle of air developing or indicated 709, the process can alert for the possibility of a forming air funnel 711. Alternatively, the process may determine the air directional changes are random, resulting from possible severe but random airflow (such as gusting) and may issue a gusting warning and also continue to monitor for a potentially more dangerous cyclic alignment of airflow. The process can repeat the monitoring until an alert is issued or the airflow aligns as weather subsides 713.

Through use of a number of vehicles in a highly localized area, and the native sensor capabilities of those vehicles in conjunction with any addition desired data relating to weather, a fairly detailed snapshot of highly localized weather can be determined at any time. A central processor can determine what sources of data (which sensors, for example) are most useful to further a weather prediction and specifically request more of that data from all or from certain vehicles.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive recorded weather-related observation data from a plurality of vehicles in a building locality;
combine the received weather-related observation data with remote weather data received from a remote source; and
determine a weather pattern developing in the building locality based on the combined weather-related observation data and the remote weather data.

2. The system of claim 1, wherein the building locality is a building parking lot.

3. The system of claim 1, wherein the observation data includes wind direction and speed data represented by readings from vehicle accelerometers.

4. The system of claim 1, wherein the observation data includes visibility data represented by readings from vehicle pyrometers.

5. The system of claim 1, wherein the observation data includes precipitation data represented by readings from vehicle rain sensors.

6. The system of claim 1, wherein the observation data includes data gathered by vehicle barometers, humidity measuring devices, microphones, infrared sensors or ultrasonic sensors.

7. The system of claim 1, wherein the processor is further configured to:
determine a data type needed to enhance weather pattern determination for a present weather pattern; and
request data corresponding to the determined data type from the plurality of vehicles.

8. The system of claim 7, wherein the request is made to all of the plurality of vehicles.

9. The system of claim 7, wherein the processor is further configured to determine a non-zero subset of less than all of the plurality of vehicles, wherein location characteristics of vehicles in the subset correlate to weather pattern determination, and wherein the request is made to the non-zero subset of vehicles.

10. The system of claim 7, wherein the processor is further configured to determine a non-zero subset of less than all of the plurality of vehicles, wherein sensing capabilities of vehicles in the subset correspond to a particular weather pattern determination, and wherein the request is made to the non-zero subset of vehicles.

11. A system comprising:
a processor configured to:
receive data, indicating a light source presence, from a first vehicle providing the light source;
receive data, indicating a light source strength, from a second vehicle having a sensor capable of detecting the light source;
compare the received strength data from the second vehicle to stored strength data previously received from the second vehicle; and
determine a change in visibility based on the compared data.

12. The system of claim 11, wherein the processor is configured to identify one or more candidate vehicles as suitable second vehicles based on a location and heading of the candidate vehicles received from the candidate vehicles.

13. The system of claim 12, wherein the processor is further configured to identify the one or more candidate vehicles as suitable second vehicles based on a location and heading of the first vehicle received from the first vehicle.

14. The system of claim 11, wherein the processor is configured to notify the second vehicle when the first vehicle is providing the light source.

15. The system of claim 11, wherein the processor is located in a building and the first and second vehicles are located within a predefined distance from the building.

16. The system of claim 15, wherein the predefined distance is defined by geographic boundaries assigned to a building parking lot associated with the building.

17. A system comprising:
a processor configured to:
receive wind data from a plurality of vehicles located within a predefined distance of each other and more than a predefined distance apart from each other;
compare directional wind data included with the wind data; and
determine a shape of a local wind pattern based on the comparison.

18. The system of claim 17, wherein the wind data also includes wind force data.

19. The system of claim 17, wherein the processor is further configured to issue an based on the shape of the local wind pattern.

20. The system of claim 17, wherein the processor is further configured to request and receive repeated updated wind data from the plurality of vehicles if the shape of the local wind pattern corresponds to a shape associated with a dangerous condition forming, persisting until at least the shape of the local wind pattern no longer indicates the dangerous condition.
